(19) United States
(12) Patent Application Publication
(10) Pub. No.: US 2024/0427654 A1
(43) Pub. Date: Dec. 26, 2024

(54) DEVELOPMENT METHOD, CONTROL METHOD AND COMPUTING DEVICE

(71) Applicant: Hangzhou AliCloud Feitian Information Technology Co., Ltd., Hangzhou City (CN)

(72) Inventors: Zhibo LI, ShenZhen City (CN); Heng DU, ShenZhen City (CN); Rongtong JIN, Hangzhou (CN); Lei DING, Hangzhou (CN); Qingshan LIN, Hangzhou (CN)

(21) Appl. No.: 18/685,203

(22) PCT Filed: Jul. 1, 2022
(86) PCT No.: PCT/SG2022/050463

§ 371 Date: Feb. 20, 2024

(30) Foreign Application Priority Data
Aug. 20, 2021 (CN) 202110963307.1

(51) Int. Cl. G06F 9/54; G06F 9/445

(52) U.S. Cl. CPC G06F 9/546; G06F 9/44526; G06F 2209/548

(57) ABSTRACT

Embodiments of the present application provide a development method, a control method and a computing device. A node of a message queue system reserves an interface before and/or after a processing component that performs any processing operation is called, determines a plug-in file obtained from development of a plug-in based on a reserved interface, and deploys the plug-in file to a designated storage location in the node. The node detects a trigger event for any processing component. If an interface is reserved before the processing component is called, a first plug-in corresponding to the interface is called; the processing component is called according to an execution result of the first plug-in, to process the trigger event; and after an execution of the processing component is completed, if an interface is reserved after the processing component is called, a second plug-in corresponding to the interface is called.

### CROSS-REFERENCE TO RELATED APPLICATIONS

This application is a National Stage of International Application No. PCT/SG2022/050463, and filed on Jul. 1, 2022, which claims priority to Chinese patent application No. 202110963307.1, and filed to the China National Intellectual Property Administration on Aug. 20, 2021. The disclosures of the aforementioned applications are hereby incorporated by reference in their entireties.

### TECHNICAL FIELD

Embodiments of the present application relate to the field of message processing technology and, in particular, to a development method, a control method and a computing device.

### BACKGROUND

A message queue (MQ) system uses a message middleware mechanism to implement a message delivery. A producer of a message sends the message to a server, and the server stores the message in a message queue, and then forwarded the message to a message consumer at an appropriate time, thus implementing synchronous or asynchronous, and reliable message transmission.

In actual applications, when different users use the message queue system, they often have their own usage demands. For example, it may be desirable to store messages using a specific storage engine instead of a designated storage engine. At this time, it is necessary to modify a kernel code of the message queue system to make that possible, which may destroy the implementation of other functions and thus increase the instability of the system.

### SUMMARY

Embodiments of the present application provide a development method, a control method, and a computing device, to solve the technical problem that the message queue system in the prior art cannot meet the personalized demands.

In a first aspect, an embodiment of the present application provides a development method, including:
determining a processing flow of any node in a message queue system, where the processing flow involves at least one processing operation;
reserving an interface before and/or after a processing component that performs any processing operation in the node is called;
determining a plug-in file obtained from development of a plug-in based on at least one reserved interface;
deploying the plug-in file to a designated storage location in the node.

In an implementation, the message queue system is a RocketMQ system.

In an implementation, the plug-in file includes a code package file and a description file; the description file defines an identification, a version, a calling priority and a calling class library of the plug-in;
the deploying the plug-in file to the designated storage location in the node includes:
determining whether an existing file having a same identification as the plug-in file exists in the designated storage location;
if so, using the plug-in file to update the existing file.

In an implementation, the method further includes:
defining, in a software development kit, the interface reserved in the node, where the plug-in file is obtained specifically by selecting, according to a to-be-extended function, at least one interface from the software development kit for the development of the plug-in.

In an implementation, the node is a broker server; the broker server includes a client processing component that is called based on any request sent by a producer or a consumer; the broker server reserves an interface at least before the client processing component is called; a plug-in developed based on the interface reserved before the client processing component is called includes an authentication plug-in for authenticating the request;
or,
the node is a broker server; the broker server includes a transaction message production component that is called based on a half transaction message published by the producer and a transaction message confirmation component that is called based on a transaction message confirmation notification submitted by the producer;
in the broker server, an interface is reserved at least before the transaction message production component is called and an interface is reserved at least before the transaction message confirmation component is called; a plug-in developed based on the interface reserved before the transaction message production component is called includes a transaction message production plug-in for temporarily storing a transaction message published by the producer into a designated storage engine; a plug-in developed based on the interface reserved before the transaction message confirmation component is called includes a transaction message confirmation plug-in for writing, from the designated storage engine, multiple half transaction messages belonging to a same transaction as transaction messages into a message queue;
or,
the node is a broker server; a plug-in developed based on the interface reserved before and/or after any processing component is called includes a collection plug-in for collecting and performing statistics on message trajectory data of any message;
or,
the node is a broker server; the broker server includes a message storage component which writes a message published by the producer into a message queue and delivers messages subscribed by all three-months message subscribers to the consumer; an interface is reserved after the message storage component is called; a plug-in developed based on the interface reserved after the message storage component is called includes an indicator statistics plug-in for collecting and performing statistics on indicator data of the message queue;
or,
the node is a name server; the name server includes a general-purpose processing component; an interface is reserved in the name server at least before the general-purpose processing component is called; an interface is reserved before the general-purpose processing component is called; a plug-in developed based on the interface reserved before the general-purpose processing component is called includes a service discovery plug-in for feeding back routing information to the producer or the consumer according to a message acquisition request sent by the producer or the consumer.

In a second aspect, an embodiment of the present application provides a control method, applied to a node of a message queue system, including:
scanning a plug-in file in a designated storage location and loading a corresponding plug-in;
when a trigger event for any processing component is detected, if an interface is reserved before the processing component is called, calling at least one first plug-in corresponding to the interface reserved before the processing component is called, to implement at least one first operation;
calling, according to an execution result of the at least one first plug-in, the processing component, to process the trigger event;
after an execution of the processing component is completed, if an interface is reserved after the processing component is called, calling at least one second plug-in corresponding to the interface reserved after the processing component is called, to implement at least one second operation.

In an implementation, the message queue system is a RocketMQ system.

In an implementation, the method further includes:
feeding back a processing result of the processing component according to an execution result of the at least one second plug-in.

In an implementation, the calling the at least one first plug-in corresponding to the interface reserved before the processing component is called, to implement at least one first operation includes:
calling the at least one first plug-in corresponding to the interface in sequence according to a calling priority of the at least one first plug-in corresponding to the interface;
the calling the at least one second plug-in corresponding to the interface reserved after the processing component is called, to implement the at least one second operation includes:
calling the at least one second plug-in in sequence according to a calling priority of the at least one second plug-in corresponding to the interface.

In an implementation, the scanning the plug-in file in the designated storage location and loading the corresponding plug-in includes:
scanning the plug-in file in the designated storage location and using a different class loader to load the corresponding plug-in.

In an implementation, the node includes a broker server; the broker server includes a client processing component that is called based on any request sent by a producer or a consumer; the at least one first plug-in includes an authentication plug-in for authenticating the request;
or,
the node is a broker server; the broker server includes a transaction message production component that is called based on a half transaction message published by the producer and a transaction message confirmation component that is called based on a transaction message confirmation notification submitted by the producer; at least one first plug-in corresponding to the transaction message production component includes a transaction message production plug-in for temporarily storing a transaction message published by the producer into a designated storage engine; at least one first plug-in corresponding to the transaction message confirmation component includes a transaction message confirmation plug-in for writing, from the designated storage engine, multiple half transaction messages belonging to a same transaction as transaction messages into a message queue;
or,
the node is a broker server; the at least one first plug-in or the at least one second plug-in includes a collection plug-in for collecting and performing statistics on message trajectory data of any message;
or,
the node is a name server; the name server includes a general-purpose processing component; the at least one first plug-in includes a service discovery plug-in for feeding back routing information to the producer or the consumer according to a routing acquisition request from the producer or the consumer.

In a third aspect, an embodiment of the present application provides a computing device, including a processing component and a storage component; the storage component stores one or more computer instructions; and the one or more computer instructions are used to be called and executed by the processing component, to implement the control method described in the second aspect above.

In the embodiments of the present application, according to a processing flow of a node in a message queue system, an interface is reserved before and/or after a processing component of any processing operation involved in the processing flow is called, so that a plug-in that implements a corresponding function can be developed based on the reserved interface. Before or after the processing component is called, the corresponding plug-in can be called to perform a corresponding operation. A corresponding function in the message queue system can be implemented in the form of a plug-in, which facilitates node updates and modifications without modifying the kernel code and thus it will not affect node stability and can meet the personalized demands of different users, which improves system flexibility.

These and other aspects of the present application will be more clearly understood in the following description of the embodiments.

### BRIEF DESCRIPTION OF DRAWINGS

In order to more clearly illustrate the technical solutions of embodiments of the present application or the prior art, the following will briefly introduce the drawings required for the description of the embodiments or the prior art. Obviously, the drawings in the following description are some embodiments of the present application. For those of ordinary skill in the art, other drawings can be obtained based on these drawings without creative effort.

FIG. 1 shows a schematic structural diagram of an embodiment of a message queue system provided by the present application.

FIG. 2 shows a flow chart of an embodiment of a development method provided by the present application.

FIG. 3 shows a flow chart of an embodiment of a control method provided by the present application.

FIG. 4 shows a flow chart of another embodiment of a development method provided by the present application.

FIG. 5 shows a flow chart of another embodiment of a control method provided by the present application.

FIG. 6 shows a flow chart of another embodiment of a development method provided by the present application.

FIG. 7 shows a flow chart of another embodiment of a control method provided by the present application.

FIG. 8 shows a schematic structural diagram of an embodiment of a development apparatus provided by the present application.

FIG. 9 shows a schematic structural diagram of an embodiment of a computing device provided by the present application.

FIG. 10 shows a schematic structural diagram of an embodiment of a control apparatus provided by the present application.

FIG. 11 shows a schematic structural diagram of another embodiment of a computing device provided by the present application.

### DESCRIPTION OF EMBODIMENTS

In order to enable those skilled in the art to better understand the solution of the present application, the technical solution in the embodiments of the present application will be clearly and comprehensively described below in conjunction with the drawings in the embodiment of the present application.

Some of the processes described in the specification and claims of the present application and the above-mentioned drawings contain multiple operations that appear in a specific order, but it should be clearly understood that these operations may be performed not in the order in which they appear herein or may be performed in parallel. The sequence number of the operations, such as 101, 102, etc., are only used to distinguish different operations. The sequence number itself does not represent any execution order. Additionally, these processes can include more or fewer operations, and these operations can be performed sequentially or in parallel. It should be noted that the descriptions such as “first” and “second” herein are used to distinguish different messages, devices, modules, etc., and do not represent the order, nor do they limit “first” and “second” as different types.

The technical solutions of the embodiments of the present application are mainly applied to a message queue (MQ) system to realize customization of node functions in the message queue system and ensure system stability.

The message queue system can be, for example, a RocketMQ system. The RocketMQ system is a distributed, open source message queue system with low latency, high concurrency, high availability, high reliability and other characteristics, and is therefore widely used in the field of message processing. The RocketMQ system, like other types of message queue systems, also supports message publication and subscription, and also supports some special functions, such as the implementation of transaction messages, scheduled messages, and delayed messages.

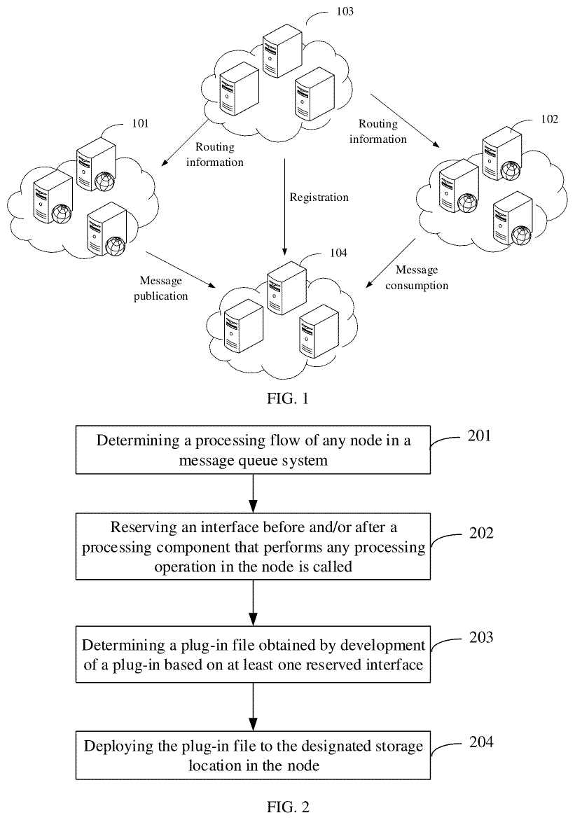

The message queue system can be composed of a producer, a consumer and a server, where the server can refer to message middleware, etc. In order to facilitate understanding, as shown in FIG. 1, a schematic structural diagram of a message queue system is shown. The message queue system can be composed of a producer 101, a consumer 102, and a name server 103 and a broker server 104, in which each of the producer, the consumer, the name server and the broker server can be deployed in a cluster form and consist of multiple nodes. The producer and the consumer are clients compared to the name server and the broker server. In a practical application, for example, the RocketMQ system is implemented by using the structure shown in FIG. 1.

Combined with the system structural diagram shown in FIG. 1, the technical terms that may be involved herein are first explained accordingly.
Message: a carrier that carries and transmits information in a message queue.
Topic: a message type. A published message belongs to a certain type which is called Topic.
Broker server: a node that provides publication/subscription functions in the message queue system and serves as a message broker, responsible for storing messages, forwarding messages, etc.
Message queue: for each Topic, there is one or more message queues to store messages.
Name server: a node for storing routing information in the message queue system. The routing information can include a broker server list and a topic list in the broker server. The broker server list to which a published/subscribed topic belongs can be obtained through the name server. After the startup of the broker server, it will send a registration request to each name server and report its own address, Topic list and other metadata.
Producer: also known as a message publisher, responsible for producing and sending messages. In the message queue system, a producer randomly establishes a long connection with a command server, obtains a broker server where a Topic of a to-be-published message is located from the command server, then establishes a long connection with this broker server, and regularly sends heartbeat packets to the broker server.
Consumer: also known as a message subscriber, responsible for receiving and consuming messages. In the message queue system, a consumer also randomly establishes a long connection with a name server, obtains a broker server where a subscribed Topic is located from the name server, and then establishes a long connection with the broker server.
Partition: for each Topic, there is at least one partition, and messages are specifically published to the partition.
Production offset: used to indicate a production quantity of messages in the partition.
Consumption offset: used to indicate a consumption quantity of messages in the partition.
Message trajectory: complete link information of an aggregation of processing time, processing location and other data of each relevant node during a processing process of a message sent from a producer to a consumer for consumption.
Indicator collection: collection of at least one indicator data that represents a running status of a message queue; the at least one indicator data includes, for example, a number of message production/consumption, a size of message production/consumption, a number of successes of message production/consumption, a number of failures of message production/consumption, etc.
Scheduled message: a producer sends a message to a broker server, but does not expect the message to be delivered immediately. Instead, the delivery of the message to a consumer for consumption is postponed to a certain time after a current time point. Such a message is a scheduled message. The scheduled message published by the producer will be temporarily stored in a storage engine, and then written to the message queue upon reaching a certain time.
Delayed message: a producer sends a message to a broker server, but does not expect the message to be delivered immediately. Instead, the message is delayed by a certain period of time before being delivered to a consumer for consumption. Such a message is a delayed message. The delay message published by the producer will be temporarily stored in a storage engine, delayed by a certain period of time, and then written to the message queue.
Transaction message: multiple messages are either consumed at the same time or not consumed at all. Messages with this characteristic are transaction messages. A producer publishes a plurality of half transaction messages carrying a same transaction identification. A broker server temporarily stores the half transaction messages in a storage engine. When finishing transaction execution, the producer sends a confirmation request to the broker server. The broker server then write the temporarily stored plurality of half transaction messages belonging to same transaction, as transaction information, into a message queue.
Storage engine: it can refer to a memory, a file system, or a third-party middleware such as HDFS (Hadoop Distributed File System), RDB (Relational Database), etc., which supports reading functions.
Processing component: it can be understood as a program module or a logical processor in a node that is used to perform processing operations. A processing component can perform at least one processing operation.
Processing flow: it consists of at least one processing operation. Different types of nodes involve different processing flows. For example, a message queue system can include a production flow, a consumption flow, a routing information change flow, etc.
Interface: it may refer to an API (Application Programming Interface) in embodiments of the present application, which is used to provide a set of routines that programs and developers can access based on certain software or hardware without having to access the source code or understand details of an internal working mechanism.

In the embodiments of the present application, in order to improve the flexibility of the message queue system, realize the customization of node functions, and meet the personalized demands of the user, the inventors proposed the technical solution of the present application after a series of studies. In the embodiments of the present application, according to a processing flow of a node in a message queue system, an interface is reserved before and/or after a processing component of any processing operation involved in the processing flow is called, so that plug-ins that implement corresponding functions can be developed based on the reserved interfaces. Before or after the processing component is called, the corresponding plug-in can be called to perform a corresponding operation. A corresponding function can be implemented in the form of a plug-in, which facilitates function updates and modifications without modifying the kernel code and thus it will not affect node stability and can meet the personalized demands of different users, which improves system flexibility.

The technical solutions of the embodiments of the present application will be clearly and comprehensively described below with reference to the accompanying drawings in the embodiments of the present application. Obviously, the described embodiments are only some of the embodiments of the present application, rather than all of the embodiments. All other embodiments obtained by those skilled in the art based on the embodiments of the present application without creative effort fall within the protection scope of the present application.

FIG. 2 is a flow chart of an embodiment of a development method provided by an embodiment of the present application. The method may include the following steps.

201: determining a processing flow of any node in a message queue system.

The processing flow may involve at least one processing operation, that is, the processing flow may be composed of at least one processing operation. A processing flow includes a plurality of processing operations, and there may be an execution order for the plurality of processing operations. In an implementation, a node may involve one or more processing flows, and different processing flows are used to achieve different processing purposes. For example, at a broker server, there may be a production flow, a consumption flow, etc.

In an implementation, the message queue system may be, for example, a RocketMQ system. Of course, the technical solutions of the embodiments of the present application can be applied to any message queue system, such as HiveMQ, etc.

Any node in the message queue system can be a producer, a consumer, a name server or a broker server. The message queue system mainly involves a production flow, a consumption flow, an information acquisition flow, etc.

For example, the information acquisition flow at a name server may include: receiving a connection establishment request sent from a producer/a consumer; establishing a long connection with the producer/the consumer; and sending routing information to the producer/the consumer and other processing operations.

The production flow at a producer may include, for example, sending a connection establishment request to a name server; establishing a long connection with the name server; requesting routing information from the name server; determining a broker server where a Topic of a to-be-published message is located; sending a connection establishment request to the broker server; establishing a long connection with the broker server; publishing a message to the broker server and other processing operations.

The consumption flow at a consumer may include, for example, sending a connection establishment request to a name server; establishing a long connection with the name server; requesting routing information from the name server; determining a broker server where a Topic of a to-be-consumed message is located; sending a connection establishment request to the broker server; establishing a long connection with the broker server; obtaining the to-be-consumed message from the broker server, etc.

The production flow at a broker server may include, for example, receiving a connection establishment request from a producer; establishing a long connection with the producer; receiving a message published by the producer; writing the message to a message queue, etc.

The consumption flow at a broker server may include, for example, receiving a connection establishment request from a consumer; establishing a long connection with the consumer; receiving a message subscription request from the consumer; delivering a message of the consumer's subscription topic to the consumer, etc.

The processing flow of a node can be pre-configured, etc., based on an actual situation and actual needs of function customization.

202: reserving an interface before and/or after a processing component that performs any processing operation in the node is called.

At each node, at least one processing component processes a processing operation. In an implementation, a processing component can perform one or more processing operations in one processing flow, or can perform one or more processing operations in multiple processing flows, etc., and the present application does not impose specific restrictions on this, which can be set according to actual application conditions. For any processing component being called to perform any processing operation in any processing flow, interface reservation can be performed in an operating system of the node before and/or after the processing component is called. Of course, interface reservation can also be performed before and/or after a processing component that is selected according to actual needs to perform a specific processing operation is called.

For example, a broker server can include a client processing component to process various requests sent by consumers or producers, and can also include a message sending component, a message storage component, a message acquisition component, a consumer management component, and a consumption offset management component, etc. The message sending component can receive a message published by a producer and received by the client processing component, and then send the message to the message storage component. The message storage component is responsible for writing the message to a message queue. The consumer management component is responsible for receiving a consumer's consumption offset acquisition request, querying a consumption offset from the consumption offset management component, and feeding back the consumption offset to the consumer. The message acquisition component is used to process a message acquisition request sent by the consumer based on the consumption offset, read a message from a message queue in the message storage component and feedback the message to the consumer, etc. In addition, the broker server may also include message processing components that process scheduled messages, delayed messages or transaction messages respectively, to receive scheduled messages, delayed messages or transaction messages published by producers and received by the client processing component, and to publish messages according to corresponding processing modes.

For another example, a name server can include a general-purpose processing component for receiving metadata sent by each broker server, and can feed back routing information to a producer or a consumer based on the producer or consumer's connection establishment request.

In embodiments of the present application, specifically, in the node system, the interface can be reserved before any processing component is called, or after any processing component is called. Plug-ins can be thus developed based on these interfaces to extend node functions.

Plug-in (also known as addin, add-in, addon or add-on) refers to a program written by an interface following a certain standard.

203: determining a plug-in file obtained from development of a plug-in based on at least one reserved interface.

According to the interface reserved in the node, a developer or a user of the message queue system can select one or more interfaces for plug-in development to generate the plug-in file.

The plug-in file may include a code package file and a description file. The code package file provides a plug-in source code, etc. The description file can define an identification, a version, a calling priority, a calling class library of the plug-in, etc.

The code package file can be a jar package, and the description file can be an xml file, etc.

204: deploying the plug-in file to the designated storage location in the node.

In order to facilitate plug-in loading, the plug-in file can be deployed in the designated storage location in the node, so that the plug-in file can be scanned from the designated storage location to implement plug-in loading, etc.

In some embodiments, in order to facilitate plug-in development, for example, the interface reserved in the node can be defined in a software development kit (SDK).

Plug-in file can be obtained specifically by selecting, according to a to-be-extended function, at least one interface from the software development kit for plug-in development.

In an implementation, function development in a form of a plug-in can facilitate updates and modifications. The deploying the plug-in file to the designated storage location in the node can include:
determining whether an existing file having a same identification as the plug-in file exists in the designated storage location;
if so, using the plug-in file to update the existing file.

In an implementation, the existing file may be replaced or modified by the plug-in file or the plug-in file may be added to the existing file, to implement a plug-in update.

In addition, using the plug-in file to update the existing file can also occurs when there is an existing file having the same identification as the plug-in file but having a different version than the plug-in file in the designated storage location, etc.

In the embodiment, according to a processing flow of a node in a message queue system, a processing component that performs any processing operation in the processing flow is determined, and an interface is reserved before and/or after the processing component is called. Based on the reserved interface, a plug-in that implements a corresponding function can be developed. The plug-in file is deployed in the designated storage location in the interface, so that the node can first call the plug-in corresponding to the interface before or after calling the processing component with the reserved interface, to implement the corresponding function. The corresponding function in the message queue is implemented in the form of the plug-in, which facilitates node updates and modifications without modifying the node's kernel code and thus it will not affect stability of the node system and can meet the personalized demands of different users, which improves flexibility.

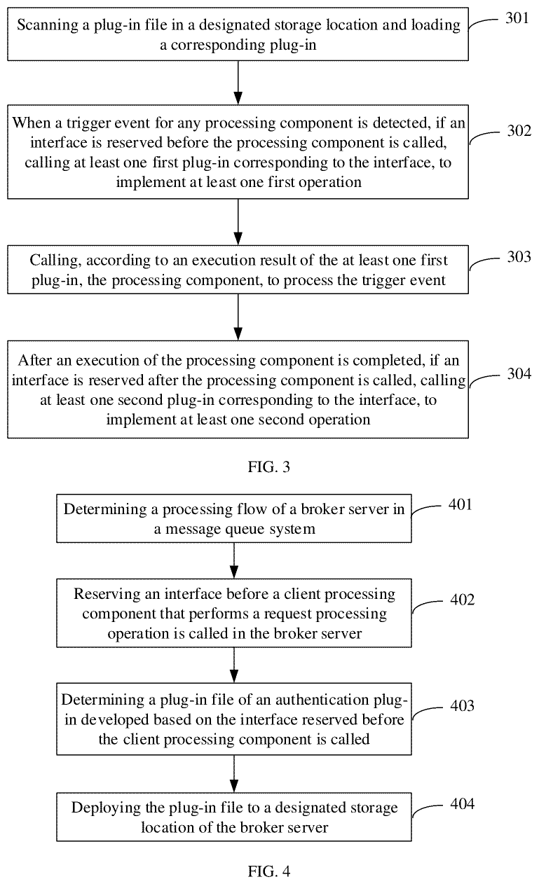

Corresponding to the development method shown in FIG. 2, as shown in FIG. 3, an embodiment of the present application also provides a control method, which can be executed by a node of a message queue system. The message queue system can be, for example, a RocketMQ system. The node can refer to a producer, a consumer, a broker server or a name server. The method can include the following steps.

301: scanning a plug-in file in a designated storage location and loading a corresponding plug-in.

The specific development method of the plug-in and the method of generating the plug-in file can be seen in detail in the embodiments shown in FIG. 2, and will not be repeated again here. Since the plug-in file is deployed in the designated storage location, the plug-in file can be scanned and obtained from the designated storage location, and the corresponding plug-in can be loaded based on the plug-in file.

In an implementation, the operation of step 301 may be performed after the startup of the node.

The designated storage location can store plug-in files for multiple plug-ins. After the startup of the node, all plug-in files in the designated storage location are scanned, so that all plug-ins can be loaded and run.

Plug-in loading requires loading a class library used by a class file in the plug-in. In order to ensure avoiding conflicts caused by different plug-ins using a same class library but in different versions, In an implementation, the plug-in files in the designated storage location can be scanned, and respective plug-ins are loaded using different class loaders, to avoid conflicts caused by loading different versions of the same class library.

In an implementation, the class library can be a class library other than that used by the software development kit, and different plug-ins can be loaded using different class loaders. For the class library used by the software development kit, since the versions are consistent, different plug-ins can be loaded using a same class loader.

302: when a trigger event for any processing component is detected, if an interface is reserved before the processing component is called, calling at least one first plug-in corresponding to the interface, to implement at least one first operation.

In actual applications, the trigger event of the processing component will trigger the calling and execution of the processing component to process the trigger event, that is, to perform a processing operation corresponding to the trigger event. For example, the trigger event can be any request sent by a producer or a consumer, or when the processing flow involves multiple processing operations, the trigger event can refer to a triggering instruction of a current processing operation, and the triggering instruction can be generated based on a processing result of a previous processing operation, etc.

If an interface is reserved before the processing component is called, at least one first plug-in developed based on the interface can be called here to implement at least one first operation.

In addition, if the interface corresponds to a plurality of first plug-ins, the plurality of first plug-ins can be called in sequence according to calling priorities of the plurality of first plug-ins. Therefore, calling the at least one first plug-in corresponding to the interface may include: calling the at least one first plug-in corresponding to the interface in sequence according to a calling priority of the at least one first plug-in corresponding to the interface, where the plug-in file pre-stored to the designated storage location includes a description file, and the description file defines a calling priority of the plug-in.

In addition, since a processing component may be called based on multiple different trigger events, and the plug-in developed based on the interface reserved before or after the processing component is called may only be applicable to certain trigger events, when the at least one first plug-in corresponding to the interface is called, any first plug-in may perform a do-nothing operation based on a trigger event, that is, the first operation is a do-nothing operation, the first plug-in does not perform any processing operation, the first operation is a do-nothing operation with a corresponding operation result being null, etc.

303: calling, according to an execution result of the at least one first plug-in, the processing component, to process the trigger event.

After all execution of the at least one first plug-in is completed, the execution result can be obtained, and may include an operation result of each first operation, etc. Afterwards, the processing component can be called to handle the trigger event based on the execution result.

In an implementation, the execution result may include execution success or execution failure, etc. Subsequent operations triggered by different execution results may be defined in the plug-in, so that after execution of at least one first plug-in is completed, it may be determined whether to call the processing component to process the trigger event based on the execution result, etc. For example, if the execution is successful, the processing component can be called, otherwise the processing flow can be ended, etc.

In addition, since there is a case where the first operation performed by the first plug-in is a do-nothing operation, that is, the execution result may also be null. At this time, if the execution result is null, the processing component is also called to process the trigger event.

In addition, as another approach, in some implementations, the first operation performed by the at least one first plug-in refers to a processing operation for the trigger event. At this time, the processing operation of the processing component to process the trigger event may be a do-nothing operation, or may be: based on the execution result, feeding back an execution result or triggering an execution of a next processing operation, etc. Feeding back the execution result can be feeding back to a producer or a consumer or to a processing component that performs the next processing operation, etc., and can be set based on actual operating conditions.

304: after an execution of the processing component is completed, if an interface is reserved after the processing component is called, calling at least one second plug-in corresponding to the interface, to implement at least one second operation.

After the execution of the processing component is completed, if an interface is also reserved after the processing component is called, at least one second plug-in corresponding to the interface can be called to implement at least one second operation.

In an implementation, if the interface corresponds to a plurality of second plug-ins, the plurality of second plug-ins can be called in sequence according to calling priorities of the plurality of second plug-ins. Therefore, the calling the at least one second plug-in corresponding to the interface to implement the at least one second operation may include: calling the at least one second plug-in in sequence according to a calling priority of the at least one second plug-in corresponding to the interface.

In addition, any first plug-in can choose to perform or not perform the first operation according to the trigger event. For not performing the first operation, the execution result of the first operation is null, etc.

It should be noted that the “first” and “second” in the first plug-in and the second plug-in are only used to linguistically distinguish the plug-ins corresponding to the interface before being called and the interface after being called, and do not mean that the first plug-in and the second plug-in are in a relationship such as a progressive relationship or a causal relationship.

In the embodiment, an interface can be reserved before and/or after any processing component in the node of the message queue system is called, so that the plug-in developed based on the interface in the node can be loaded upon a startup of the node. Moreover, before any processing component is called, if there is an interface therein, at least one first plug-in corresponding to the interface is first called to implement at least one first operation. After execution of the at least one first plug-in, the processing component is called for execution. After execution of the processing component is completed, if an interface exists, at least one second plug-in corresponding to the interface can be continued to be called to implement at least one second operation. Different functional operations can be realized through plug-ins, and since plug-ins are easy to update and modify, there is no need to modify the node's kernel code, which will not affect the stability of the node system, and can meet the personalized demands of different users, thereby improving node flexibility.

After the execution of the processing component is completed, a processing result can be directly fed back. In some implementation cases, the processing result of the processing component can also be fed back based on an execution result of the at least one second plug-in.

The execution result may include, for example, execution success or execution failure. If the execution is successful, the processing result of the processing component is then fed back. If the execution fails, the flow may be ended or a notification of execution failure of the processing component may be fed back, etc.

The processing result of the processing component can be used as a new trigger event to trigger the calling of any processing component, etc. In addition, based on the foregoing description, it can be known that, in some implementation cases, the processing result of the processing component may include the execution result of the at least one first plug-in.

Of course, in some implementation situations, the processing result may also include an execution result of the at least one second plug-in, etc.

In practical applications, an interface can be reserved in a producer, a consumer, a broker server or a name server of a message queue system to develop a plug-in to meet a specific requirement, such as function development for achieving user personalized requirements or facilitating modifications and updates or other requirements.

For example, for a broker server, the broker server can include a client processing component that is called based on any request sent by a producer or a consumer.

The broker server can reserve an interface at least before the client processing component is called; a plug-in developed based on the interface reserved before the client processing component is called includes an authentication plug-in for authenticating the request.

Correspondingly, when the broker server detects a trigger event for the client processing component, at least one first plug-in called may include the authentication plug-in for authenticating the request; and the client processing component processes the request at least after successful authentication of the authentication plug-in.

The trigger event for the client processing component can refer to a receipt of any request sent by a producer or a consumer. The any request can include, for example, a connection establishment request, a heartbeat request, a message publication request, or a message consumption request, etc.

For another example, for the broker server, the broker server may include a transaction message production component that is called based on a half transaction message published by the producer and a transaction message confirmation component that is called based on a transaction message confirmation notification submitted by the producer.

The broker server can at least reserve an interface before the transaction message production component is called and reserve an interface before the transaction message confirmation component is called; a plug-in developed based on the interface reserved before the transaction message production component is called includes a transaction message production plug-in for temporarily storing a half transaction message published by the producer into a designated storage engine; a plug-in developed based on the interface reserved before the transaction message confirmation component is called includes a transaction message confirmation plug-in for writing, from the designated storage engine, multiple half transaction messages belonging to a same transaction as transaction messages into a message queue.

Correspondingly, the broker server detects a trigger event for the transaction message production component, and the at least one first plug-in called includes the transaction message production plug-in for temporarily storing the half transaction message published by the producer into the designated storage engine.

In response to a detection of the trigger event for the transaction message confirmation component, the at least one plug-in called includes the transaction message confirmation plug-in for writing, from the designated storage engine, multiple half transaction messages belonging to a same transaction as transaction messages into a message queue.

The trigger event for the transaction message production component may include a receipt of a producer's transaction message application request, a producer's transaction message publication request, etc., where the transaction message application request is used to obtain a transaction identification, and the transaction message publication request includes a half transaction message published based on the transaction identification, etc. The transaction message production plug-in may perform a do-nothing operation based on the transaction message application request. The transaction message production component processes the transaction message application request and allocates a transaction identification to the producer. The transaction message production plug-in may temporarily store a published half transaction message in the designated storage engine based on the transaction message publication request. Based on an execution result of a transaction message processing plug-in, a transaction message processing component can feedback a processing confirmation notification to the producer.

The trigger event for the transaction message confirmation component can include a receipt of a transaction message confirmation request corresponding to the producer, etc. The transaction message confirmation plug-in can write, based on the transaction message confirmation request, half transaction messages belonging to the same transaction in the designated storage engine into the message queue, etc. The transaction message confirmation component is used to feedback a processing confirmation notification to the producer, etc.

The transaction message application request, the transaction message publication request, and the transaction message confirmation request mentioned above can be sent to the transaction message production component or the transaction message confirmation component via the client processing component. Then, before the client processing component is called, that is, before these requests are sent, based on the previous description, it can be known that the authentication plug-in can be called first to authenticate the producer. After the authentication is successful, the client processing component can then be called to send the request to the transaction message production component or the transaction message confirmation component.

As another example, for the broker server, a plug-in developed based on an interface that can be reserved before and/or after any processing component is called includes a collection plug-in for collecting and performing statistics on message trajectory data of any message.

Correspondingly, on the broker server, the at least one first plug-in or the at least one second plug-in called based on the interface reserved before or after any component is called can include the collection plug-in to collect and perform statistics on message trajectory data of any message.

Interface reservation can be performed both before and after each processing component is called, to develop collection plug-ins to collect and perform statistics on the message trajectory data.

For another example, for the name server, the name server can include a general-purpose processing component; the name server can reserve an interface at least before the general-purpose processing component is called; a plug-in developed based on the interface reserved before the general-purpose processing component is called includes a service discovery plug-in for feeding back routing information to the producer end or the consumer end according to an message acquisition request sent by the producer or the consumer.

Correspondingly, upon detecting the trigger event for the general-purpose processing component, the name server can call the service discovery plug-in to feedback the routing information to the producer end or the consumer end according to the message acquisition request sent by the producer or the consumer.

The trigger event for the general-purpose processing component may include a receipt of the message acquisition request sent by the producer or the consumer, a receipt of a connection establishment request sent by the producer or the consumer, and a receipt of a registration request sent by the broker server. The first operation performed by the service discovery plug-in for a trigger event other than the message acquisition request sent by the producer or the consumer can be null, that is, for the trigger event other than the message acquisition request sent by the producer or the consumer, the service discovery plug-in can perform no operation. When the first operation is null, the general-purpose processing component can be directly called to handle the trigger event, etc.

For another example, for the broker server, the broker server can include a message storage component to write a message published by the producer into a message queue, or deliver a message subscribed by the consumer from the message queue to the consumer. An interface can be reserved after the message storage component is called. Based on the interface reserved after the message storage component is called, an indicator statistics plug-in can be developed to collect and perform statistics on indicator data of the message queue. The indicator data can represent the operation status of the message queue. For example, the indicator data can include a number of message production or consumption per second, a size of message production or consumption per second, a number of successes of message production or consumption per second, a number of failures of message production or consumption per second, etc.

In an implementation, the indicator statistics plug-in can further send the indicator data to operation and maintenance personnel to facilitate the operation and maintenance personnel to understand the operation status of the system.

For another example, for the name server, a plug-in developed based on the interface reserved before the general-purpose processing component is called can also include an authentication plug-in for authenticating any request sent by the producer or the consumer. After the authentication is successful, the general-purpose processing component is then called to process the request, etc.

For another example, the broker server can further include a scheduled message processing component and a delayed message processing component. Based on different actual needs, an interface can be reserved before the scheduled message processing component is called, or an interface can be reserved before the delayed message processing component is called. A scheduled message processing plug-in can thus be developed based on the interface reserved before the scheduled message processing component is called, to temporarily store a scheduled message published by the producer into the designated storage engine, and then write into the message queue after the scheduled time is reached, etc. Of course, while the scheduled message processing plug-in can be developed based on the interface reserved before the scheduled message processing component is called, a delayed message processing plug-in can be developed based on the interface reserved before the delayed message processing component is called, to temporarily store a delayed message published by the producer into the designated storage engine, and then write the delayed message into the message queue after waiting for a certain period of time, etc.

Based on the above description, it can be seen that the plug-in developed based on the interface reserved before the general-purpose processing component is called can include the authentication plug-in and the service discovery plug-in. The authentication plug-in and the service discovery plug-in can be set with respective calling priorities, and a calling order can be determined according to the calling priorities. For example, the authentication plug-in is called first, then the service discovery plug-in is called, etc. In addition, the service discovery plug-in can be called after a successful authentication of the authentication plug-in, to be responsible for directly ending a current processing flow, etc.

The above only illustrates examples of the development and control scenarios of several functions. It should be noted that the present application is not limited to the above-mentioned implementation scenarios and will not be exhaustive here. The following mainly takes on the authentication function and transaction message processing function as an example to introduce the technical solutions of the present application in detail.

In a practical application, in order to ensure security, the broker server or the name server of the message queue system usually needs to authenticate the client (the producer or the consumer) to confirm whether the identity is legal, etc. Currently, the authentication operation is performed by the client processing component in the broker server that processes the request sent by the client. After receiving any request from the client, the client processing component first performs authentication and then decide, based on the authentication result, whether to process the request, etc. Since a user may need to use its own authentication approach for authentication, in order to update the authentication approach, the kernel code needs to be modified. With the technical solution of the embodiments of the present application, the development and modifications of the authentication function can be easily and flexibly implemented. The following takes the development of authentication operation on the broker server as an example. The development method shown in FIG. 4 can include the following steps.

401: determining a processing flow of a broker server in a message queue system.

The processing flow involves at least one processing operation, which may include a request processing operation that handles any request sent by a producer or a consumer. The request may include, for example, a connection establishment request, a message production request, a message consumption request, a heartbeat request, etc.

402: reserving an interface before a client processing component that performs a request processing operation is called in the broker server.

403: determining a plug-in file of an authentication plug-in developed based on the interface reserved before the client processing component is called.

404: deploying the plug-in file to a designated storage location of the broker server.

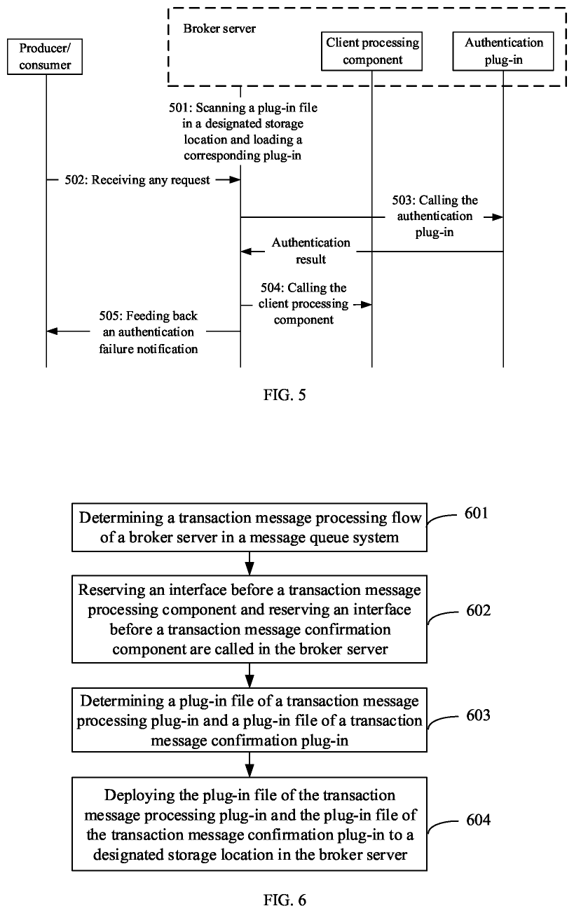

Correspondingly, as shown in FIG. 5, the control method of the broker server can include the following steps.

501: scanning a plug-in file in a designated storage location and loading a corresponding plug-in.

502: upon a receipt of any request sent from a producer or a consumer, requesting to call the client processing component.

503: if an interface is reserved before the client processing component is called, calling an authentication plug-in corresponding to the interface to perform an authentication operation.

504: if an authentication result is authentication success, calling the client processing component to process the request.

505: if the authentication result is authentication failure, feeding back an authentication failure notification to the producer or the consumer.

In another practical application, a special function of the message queue system is that it can realize transaction message processing. The processing component responsible for transaction message processing in the broker server can be divided into a transaction message production component and a transaction message confirmation component. The transaction message processing flow may include: the producer first sends a transaction message application request, and the transaction message production component assigns a transaction message identification to the producer; after receiving the transaction message identification, the producer performs transaction processing and respectively sends at least one half transaction message based on the transaction message identification; and the transaction message production component writes the at least one half transaction message to a database. After the transaction processing is completed, the producer sends a transaction message confirmation request, and the transaction message confirmation component then writes all half transaction messages in the database that belong to the same transaction into the message queue.

In practical applications, different users may wish to implement transaction messages based on different storage engines, that is, half transaction messages are temporarily stored in a specific storage engine, etc. With the technical solutions of the embodiments of the present application, transaction message processing can be easily and flexibly implemented.

In order to implement transaction message processing, the development method shown in FIG. 6 can include the following steps.

601: determining a transaction message processing flow of a broker server in a message queue system.

The transaction message processing flow involves at least one processing operation.

602: reserving an interface before a transaction message processing component and reserving an interface before a transaction message confirmation component are called in the broker server.

603: determining a plug-in file of a transaction message processing plug-in developed based on the interface reserved before the transaction message processing component is called, and a plug-in file of a transaction message confirmation plug-in developed based on the interface reserved before the transaction message confirmation component is called.

604: deploying the plug-in file of the transaction message processing plug-in and the plug-in file of the transaction message confirmation plug-in to a designated storage location in the broker server.

Correspondingly, the control method executed by the broker server is shown in FIG. 7, and can include the following steps.

701: scanning a plug-in file in a designated storage location and loading a corresponding plug-in.

702: when a trigger event for a transaction message processing component is detected, calling a transaction message processing plug-in.

703: if the trigger event is a transaction message publication request sent by a producer, using the transaction message processing plug-in to temporarily store a half transaction message in the transaction message publication request into a designated storage engine.

704: calling, based on an execution result of the transaction message processing plug-in, the transaction message processing component to feed back a corresponding processing confirmation notification to the producer to notify the producer of successful message temporary storage, etc.

705: upon a receipt of a transaction message confirmation request sent from the producer, calling a transaction message confirmation plug-in.

706: using the transaction message confirmation plug-in to write all half transaction messages belonging to a same transaction in the designated storage engine into a message queue.

707: calling, based on an execution result of the transaction message confirmation plug-in, the transaction message confirmation component to feed back a corresponding processing confirmation notification to the producer to notify the producer that the message is written successfully, etc.

In an implementation, in actual applications, the corresponding request sent by the producer can be processed accordingly by at least one other processing component and then be sent into the transaction message production component or the transaction message confirmation component. The processing confirmation notification fed back to the producer can also be sent to the producer via at least one other processing component, etc., which can be set in combination with different actual application situations, which is not specifically limited in the present application.

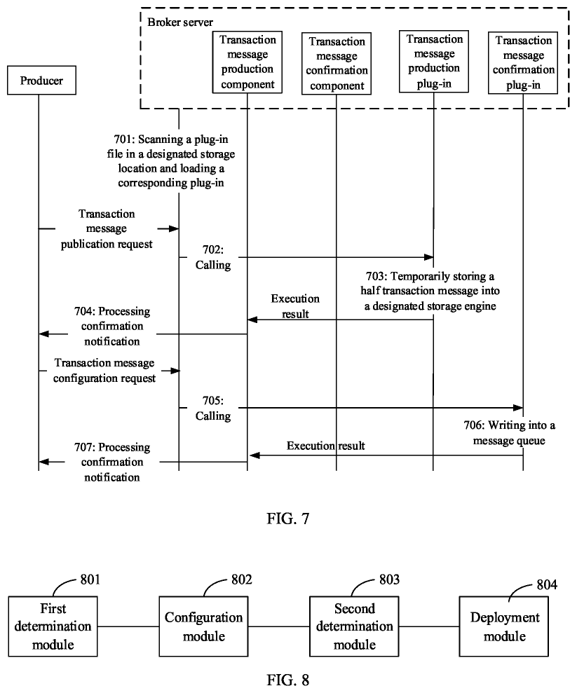

FIG. 8 is a schematic structural diagram of an embodiment of a development apparatus provided by the present application. The apparatus may include:
a first determination module 801, configured to determine a processing flow of any node in a message queue system, where the processing flow involves at least one processing operation;
a configuration module 802, configured to reserve an interface before and/or after a processing component that performs any processing operation in the node is called;
a second determination module 803, configured to determine a plug-in file obtained from development of a plug-in based on at least one reserved interface;
a deployment module 804, configured to deploy the plug-in file to a designated storage location in the node.

The development apparatus in FIG. 8 can execute the development method described in the embodiments shown in FIG. 2, and the implementation principles and technical effects thereof will not be repeated again. The specific manner in which each module and unit of the development apparatus in the above embodiment performs operations has been described in detail in the method embodiments, and will not be repeated in detail here.

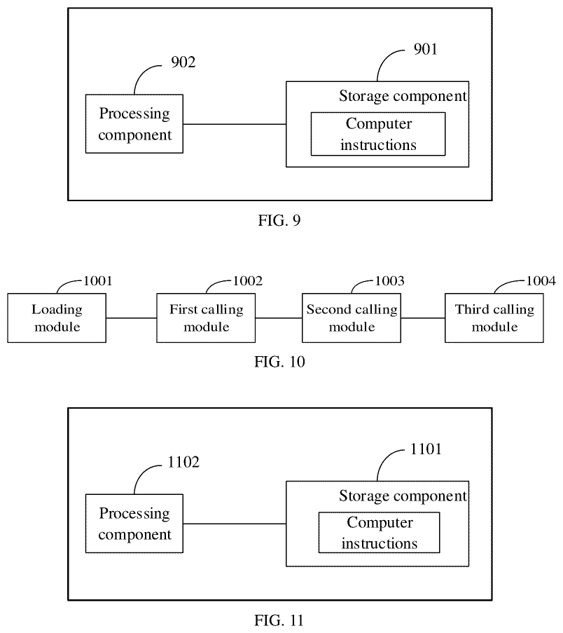

In a possible design, the development apparatus of the embodiment shown in FIG. 8 can be implemented as a computing device, as shown in FIG. 9. The computing device can include a storage component 901 and a processing component 902.

The storage component 901 stores one or more computer instructions, where the one or more computer instructions are called and executed by the processing component 902 to implement the development method shown in FIG. 2.

Of course, the computing device may also include other components, such as an input/output interface, a communication component, etc. The input/output interface provides an interface between the processing component and the peripheral interface module. The above-mentioned peripheral interface module can be an output device, an input device, etc. The communication component is configured to facilitate wired or wireless communication, etc., between the computing device and other devices.

The computing device can be a physical device or an elastic computing host provided by a cloud computing platform. In this case, the computing device can refer to a cloud server. The above-mentioned processing component, storage component, etc. can be basic server resources rented or purchased from the cloud computing platform.

When the computing device is a physical device, it can be implemented as a distributed cluster composed of multiple servers or terminal devices, or as a single server or a single terminal device.

An embodiment of the present application also provides a computer-readable storage medium storing a computer program. When the computer program is executed by a computer, the development method of the embodiment shown in FIG. 2 can be implemented.

An embodiment of the present application also provides a computer program product, including a computer program. When the computer program is executed by a computer, the development method of the embodiment shown in FIG. 2 can be implemented.

FIG. 10 is a schematic structural diagram of an embodiment of a control apparatus provided by the present application. The apparatus may include:
a loading module 1001, configured to scan a plug-in file in a designated storage location and loading a corresponding plug-in;
a first calling module 1002, configured to: when a trigger event for any processing component is detected, if an interface is reserved before the processing component is called, call at least one first plug-in corresponding to the interface, to implement at least one first operation;
a second calling module 1003, configured to call, according to an execution result of the at least one first plug-in, the processing component, to process the trigger event;
a third calling module 1004, configured to: after an execution of the processing component is completed, if an interface is reserved after the processing component is called, call at least one second plug-in corresponding to the interface, to implement at least one second operation.

The development apparatus described in FIG. 10 can execute the control method described in the embodiment shown in FIG. 3, and the implementation principles and technical effects thereof will not be repeated again. The specific manner in which each module and unit of the control apparatus in the above embodiment performs operations has been described in detail in the method embodiments, and will not be described in detail here.

In a possible design, the control apparatus of the embodiment shown in FIG. 10 can be implemented as a computing device, and as shown in FIG. 11, the computing device can include a storage component 1101 and a processing component 1102.

The storage component 1101 stores one or more computer instructions, where the one or more computer instructions are called and executed by the processing component 1102 to implement the control method shown in FIG. 3.

Of course, the computing device may also include other components, such as an input/output interface, a communication component, etc. The input/output interface provides an interface between the processing component and the peripheral interface module. The above-mentioned peripheral interface module can be an output device, an input device, etc. The communication component is configured to facilitate wired or wireless communication, etc., between the computing device and other devices.

The computing device can be a physical device or an elastic computing host provided by a cloud computing platform. In this case, the computing device can refer to a cloud server. The above-mentioned processing component, storage component, etc. can be basic server resources rented or purchased from the cloud computing platform.

When the computing device is a physical device, it can be implemented as a distributed cluster composed of multiple servers or terminal devices, or as a single server or a single terminal device.

In actual applications, the computing device can be specifically deployed as a node in a message queue system and be implemented as a producer, a consumer, a broker server or a name server in the message queue system.

An embodiment of the present application also provides a computer-readable storage medium storing a computer program. When the computer program is executed by a computer, the control method of the embodiment shown in FIG. 3 can be implemented.

An embodiment of the present application also provides a computer program product, including a computer program. When the computer program is executed by a computer, the control method of the embodiment shown in FIG. 3 can be implemented.

The processing component in the above corresponding embodiments may include one or more processors to execute computer instructions to complete all or part of the steps in the above methods. Of course, the processing component can also be one or more application-specific integrated circuits (ASIC), digital signal processors (DSP), digital signal processing devices (DSPD), programmable logic devices (PLD), field programmable gate arrays (FPGA), controllers, microcontrollers, microprocessors or other electronic components for executing the above methods.

Storage component is configured to store various types of data to support operations in the device. The storage component can be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

Those skilled in the art can clearly understand that for the convenience and simplicity of description, for the specific working processes of the above-described systems, apparatuses and units, reference can be made to the corresponding processes in the foregoing method embodiments, and will not be repeated here.

The apparatus embodiments described above are only illustrative. The units described as separate components may or may not be physically separated. The components shown as units may or may not be physical units, that is, they may be located in one location, or can be distributed across multiple network units. Some or all of the modules can be selected according to actual needs to achieve the purpose of the solution of the embodiment, which will be understood and implemented by those of ordinary skill in the art without any creative effort.

Through the above description of the implementations, those skilled in the art can clearly understand that each implementation can be implemented by means of software plus the necessary general hardware platform, and of course can also be implemented by hardware. Based on this understanding, the part of the above technical solution that essentially or contributes to the prior art can be embodied in the form of a software product. The computer software product can be stored in a computer-readable storage medium, such as a ROM/a RAM, a magnetic disk, an optical disk, etc., including a number of instructions to cause a computer device (which can be a personal computer, a server, or a network device, etc.) to execute the methods described in various embodiments or certain parts of the embodiments.

Finally, it should be noted that the above embodiments are only used to illustrate the technical solution of the present application, but not to limit it; although the present application has been described in detail with reference to the foregoing embodiments, those of ordinary skill in the art should understand that modifications can still be made to the technical solutions recorded in the foregoing embodiments, or equivalent substitutions can still be made to some of the technical features; however, these modifications or substitutions do not cause the essence of the corresponding technical solutions to deviate from the spirit and scope of the technical solutions in the embodiments of the present application.

1. A development method, comprising:
determining a processing flow of any node in a message queue system, wherein the processing flow involves at least one processing operation;
reserving an interface before and/or after a processing component that performs any processing operation in the node is called;
determining a plug-in file obtained from development of a plug-in based on at least one reserved interface; and
deploying the plug-in file to a designated storage location in the node.

2. The method according to claim 1, wherein the message queue system is a RocketMQ system.

3. The method according to claim 1, wherein the plug-in file comprises a code package file and a description file; the description file defines an identification, a version, a calling priority and a calling class library of the plug-in;
the deploying the plug-in file to the designated storage location in the node comprises:
determining whether an existing file having a same identification as the plug-in file exists in the designated storage location; and
based on that the existing file having the same identification as the plug-in file exists in the designated storage location, using the plug-in file to update the existing file.

4. The method according to claim 1, further comprising:
defining, in a software development kit, the interface reserved in the node, wherein the plug-in file is obtained by selecting, according to a to-be-extended function, at least one interface from the software development kit for the development of the plug-in.

5. The method according to claim 1, wherein the node is a broker server; the broker server comprises a client processing component that is called based on any request sent by a producer or a consumer; the broker server reserves an interface at least before the client processing component is called; a plug-in developed based on the interface reserved before the client processing component is called comprises an authentication plug-in for authenticating the request;
or,
the node is a broker server; the broker server comprises a transaction message production component that is called based on a half transaction message published by the producer and a transaction message confirmation component that is called based on a transaction message confirmation notification submitted by the producer;
in the broker server, an interface is reserved at least before the transaction message production component is called and an interface is reserved at least before the transaction message confirmation component is called; a plug-in developed based on the interface reserved before the transaction message production component is called comprises a transaction message production plug-in for temporarily storing a transaction message published by the producer into a designated storage engine; a plug-in developed based on the interface reserved before the transaction message confirmation component is called comprises a transaction message confirmation plug-in for writing, from the designated storage engine, multiple half transaction messages belonging to a same transaction as transaction messages into a message queue;
or,
the node is a broker server; a plug-in developed based on the interface reserved before and/or after any processing component is called comprises a collection plug-in for collecting and performing statistics on message trajectory data of any message;
or,
the node is a broker server; the broker server comprises a message storage component which writes a message published by the producer into a message queue and delivers messages subscribed by all three-months message subscribers to the consumer; an interface is reserved after the message storage component is called; a plug-in developed based on the interface reserved after the message storage component is called comprises an indicator statistics plug-in for collecting and performing statistics on indicator data of the message queue;
or,
the node is a name server; the name server comprises a general-purpose processing component; an interface is reserved in the name server at least before the general-purpose processing component is called; an interface is reserved before the general-purpose processing component is called; a plug-in developed based on the interface reserved before the general-purpose processing component is called comprises a service discovery plug-in for feeding back routing information to the producer or the consumer according to a message acquisition request sent by the producer or the consumer.

6. A control method, applied to a node of a message queue system, comprising:
scanning a plug-in file in a designated storage location and loading a corresponding plug-in;
when a trigger event for any processing component is detected, and based on that an interface is reserved before the processing component is called, calling at least one first plug-in corresponding to the interface reserved before the processing component is called, to implement at least one first operation;
calling, according to an execution result of the at least one first plug-in, the processing component, to process the trigger event; and
after an execution of the processing component is completed, and based on that an interface is reserved after the processing component is called, calling at least one second plug-in corresponding to the interface reserved after the processing component is called, to implement at least one second operation.

7. The method according to claim 6, wherein the message queue system is a RocketMQ system.

8. The method according to claim 6, further comprising:
feeding back a processing result of the processing component according to an execution result of the at least one second plug-in.

9. The method according to claim 6, wherein the calling the at least one first plug-in corresponding to the interface reserved before the processing component is called, to implement at least one first operation comprises:
calling the at least one first plug-in corresponding to the interface in sequence according to a calling priority of the at least one first plug-in corresponding to the interface; and
the calling the at least one second plug-in corresponding to the interface reserved after the processing component is called, to implement the at least one second operation comprises:
calling the at least one second plug-in in sequence according to a calling priority of the at least one second plug-in corresponding to the interface.

10. The method according to claim 6, wherein the scanning the plug-in file in the designated storage location and loading the corresponding plug-in comprises:
scanning the plug-in file in the designated storage location and using a different class loader to load the corresponding plug-in.

11. The method according to claim 6, wherein the node is a broker server; the broker server comprises a client processing component that is called based on any request sent by a producer or a consumer; the at least one first plug-in comprises an authentication plug-in for authenticating the request;
or,
the node is a broker server; the broker server comprises a transaction message production component that is called based on a half transaction message published by the producer and a transaction message confirmation component that is called based on a transaction message confirmation notification submitted by the producer; at least one first plug-in corresponding to the transaction message production component comprises a transaction message production plug-in for temporarily storing a transaction message published by the producer into a designated storage engine; at least one first plug-in corresponding to the transaction message confirmation component comprises a transaction message confirmation plug-in for writing, from the designated storage engine, multiple half transaction messages belonging to a same transaction as transaction messages into a message queue;
or,
the node is a broker server; the at least one first plug-in or the at least one second plug-in comprises a collection plug-in for collecting and performing statistics on message trajectory data of any message;
or,
the node is a name server; the name server comprises a general-purpose processing component; the at least one first plug-in comprises a service discovery plug-in for feeding back routing information to the producer or the consumer according to a routing acquisition request from the producer or the consumer.

12. A computing device, comprising:
a processor
a memory storing instructions and connected with the processor;
the instructions, when executed by the processor, cause the processor to:
scan a plug-in file in a designated storage location and load a corresponding plug-in;
when a trigger event for any processor is detected, and based on that an interface is reserved before the processor is called, call at least one first plug-in corresponding to the interface reserved before the processor is called, to implement at least one first operation;
call, according to an execution result of the at least one first plug-in, the processor, to process the trigger event; and
after an execution of the processor is completed, and based on that an interface is reserved after the processor is called, call at least one second plug-in corresponding to the interface reserved after the processor is called, to implement at least one second operation.

13. The method according to claim 2, wherein the plug-in file comprises a code package file and a description file; the description file defines an identification, a version, a calling priority and a calling class library of the plug-in;
the deploying the plug-in file to the designated storage location in the node comprises:
determining whether an existing file having a same identification as the plug-in file exists in the designated storage location;
based on that the existing file having the same identification as the plug-in file exists in the designated storage location, using the plug-in file to update the existing file.

14. The method according to claim 2, further comprising:
defining, in a software development kit, the interface reserved in the node, wherein the plug-in file is obtained by selecting, according to a to-be-extended function, at least one interface from the software development kit for the development of the plug-in.

15. The method according to claim 7, further comprising:
feeding back a processing result of the processing component according to an execution result of the at least one second plug-in.

16. The computing device according to claim 12, wherein the message queue system is a RocketMQ system.

17. The computing device according to claim 12, wherein the processor is further configured to:
feed back a processing result of the processor according to an execution result of the at least one second plug-in.

18. The computing device according to claim 12, the processor is further configured to:
call the at least one first plug-in corresponding to the interface in sequence according to a calling priority of the at least one first plug-in corresponding to the interface; and
the processor is further configured to:
call the at least one second plug-in in sequence according to a calling priority of the at least one second plug-in corresponding to the interface.

19. The computing device according to claim 12, the processor is further configured to:
scan the plug-in file in the designated storage location and use a different class loader to load the corresponding plug-in.

20. The computing device according to claim 12, wherein the node is a broker server; the broker server comprises a client processor that is called based on any request sent by a producer or a consumer; the at least one first plug-in comprises an authentication plug-in for authenticating the request;
or,
the node is a broker server; the broker server comprises a transaction message production component that is called based on a half transaction message published by the producer and a transaction message confirmation component that is called based on a transaction message confirmation notification submitted by the producer; at least one first plug-in corresponding to the transaction message production component comprises a transaction message production plug-in for temporarily storing a transaction message published by the producer into a designated storage engine; at least one first plug-in corresponding to the transaction message confirmation component comprises a transaction message confirmation plug-in for writing, from the designated storage engine, multiple half transaction messages belonging to a same transaction as transaction messages into a message queue;
or,
the node is a broker server; the at least one first plug-in or the at least one second plug-in comprises a collection plug-in for collecting and performing statistics on message trajectory data of any message;
or,
the node is a name server, the name server comprises a general-purpose processor, the at least one first plug-in comprises a service discovery plug-in for feeding back routing information to the producer or the consumer according to a routing acquisition request from the producer or the consumer.
